(19) United States
(12) Patent Application Publication
(10) Pub. No.: US 2007/0235240 A1
(43) Pub. Date: Oct. 11, 2007

(54) Power Steering

(75) Inventors: Peter Lauer, Karben (DE); Steffen Linkenbach, Eschborn (DE); Ralf Schwarz, Ingolstadt (DE); Oliver Hoffmann, Frankfurt am Main (DE); Joachim Nell, Hanau (DE); Steffen Troster, Metzingen (DE); Roger Bauer, Frankfurt am Main (DE)

Correspondence Address: CONTINENTAL TEVES, INC., ONE CONTINENTAL DRIVE, AUBURN HILLLS, MI, 48326-1581, US

(73) Assignee: Continental Teves AG & Co oHG

(21) Appl. No.: 10/584,731

(22) PCT Filed: Dec. 17, 2004
(86) PCT No.: PCT/EP04/53570

§ 371 Date: May 14, 2007

(30) Foreign Application Priority Data
Dec. 24, 2003 (DE) 10361231.9

(51) Int. Cl. B62D 6/04

(52) U.S. Cl. 180/204

(57) ABSTRACT

A power steering system includes a device for actively applying an additional steering torque as well as a device for actively applying a superposition steering angle.

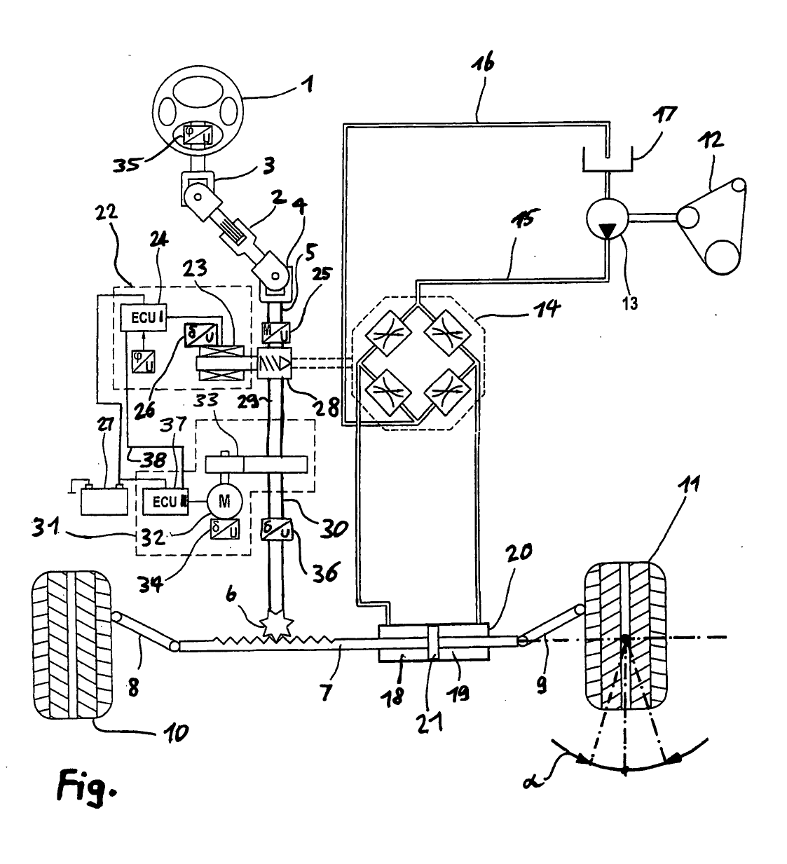

### BACKGROUND OF THE INVENTION

The present invention relates to a power steering system.

The invention likewise relates to a method of assisting the driver.

The term ‘power steering system’ relates to all steering systems, which produce a force or a torque to assist the driver in his steering activity. In particular, the term ‘power steering system’ implies steering systems with hydraulic, electrohydraulic, electromechanical, or electromagnetic actuators.

Up-to-date motor vehicles, especially passenger vehicles, are usually equipped with hydraulic or electrohydraulic power steering systems, which are referred to as ‘hydraulic power steering systems’ in the following. In the steering mechanism of the hydraulic power steering systems, hydraulic actuators, e.g. hydraulic cylinders, are arranged, which produce a force that assists the driver in activating the steering mechanism as a reaction to turning of the steering wheel.

Further, so-called ‘intelligent’ auxiliary-force actuators are known in the art, in which a defined additional steering torque (additional steering torque) can be applied to the steering column when the steering mechanism is actuated. The steering torque which is necessary for steering the vehicle, hereinbelow briefly referred to as ‘torque’, is so reduced, and the driver is assisted in the steering activity, e.g. according to a detected steering situation.

So-called superposition steering systems are also known in the art, where the steering column or the steering wheel shaft, respectively, hereinbelow briefly referred to as ‘steering shaft’, is split, and a gear that is arranged between the two steering shaft halves is used to adjust any optional differential angle, hereinbelow referred to as ‘superposition steering angle’ or briefly ‘superposition angle’, between steering wheel and wheel.

The mentioned systems render active steering interventions possible, which aim at improving the driving performance of a motor vehicle. On the one hand, interventions into driving dynamics are feasible by changing the wheel steering angle with the aid of a superposition steering system. On the other hand, the ‘intelligent’ auxiliary-force actuator can impart to the driver a haptic feedback about an additional steering torque for a position of his vehicle to be changed (preset direction). The additional steering torque can also be used to preset to the driver a direction, which improves driving dynamics.

An object of the invention involves disclosing a steering system and a method safeguarding optimum assistance of the driver in addition to great steering comfort.

### SUMMARY OF THE INVENTION

This object is achieved by a power steering system, characterized in that the power steering system includes a means for actively applying an additional steering torque as well as a means for actively applying a superposition steering angle. This object is also achieved by a method for assisting a driver, characterized in that an additional steering torque can be applied actively and, additionally, a superposition steering angle can be applied actively.

This object is achieved in that the power steering system includes a means for actively applying an additional steering torque as well as a means for actively applying a superposition steering angle.

More specifically, it is essential for the invention that a steering system with a superposition steering function additionally includes an ‘intelligent’ torque actuator. Advantageously, this power steering system provides new possibilities of assisting and changing the driver's steering instructions.

Provisions are made by the invention that the means for actively applying an additional steering torque is a functionally self-contained and independently manageable subassembly and that the means for actively applying a superposition steering angle is a functionally self-contained and independently manageable subassembly.

The means of the units of the invention for actively applying an additional steering torque and for actively applying a superposition steering angle can be integrated as functionally self-contained units into a conventional power steering system without modifications to the basic characteristics. In their capacity of an independently manageable subassembly, i.e. an independent module, these units favorably add in each case to an already existing hydraulic power steering system in order to gain in functions.

According to the invention, the means for actively applying an additional steering torque causes generation of an antitorque, which compensates, at least in part, any superposition torque generated by the means for actively applying a superposition steering angle.

This embodiment is especially favorable because it is necessary in a superposition steering system that the driver keeps hold of the steering wheel and thereby generates a supporting antitorque in order to enable an adjustment of the differential angle, i.e. adjustment of a superposition steering angle. According to the invention, this torque is adopted by way of a preceding means for actively applying an additional steering torque (force actuator). This allows presetting a course independently of the driver (vehicle operator). The preset course can be corrected when the driver applies only a small amount of force. From this results another advantage, namely that the driver maintains control of the vehicle and his responsibility of directing the vehicle.

The invention envisages that detection of the driver's activity, i.e. a determination whether the driver consciously directs the vehicle and is able to actively react to a changed driving situation, if applicable, is performed by actuating the means for actively applying an additional steering torque and by actuating the means for actively applying a superposition steering angle.

In this embodiment, a test is made as to whether the driver participates in what happens in traffic by actively turning the steering wheel, without the wheel angle changing. Thus, it is e.g. possible to detect fatigue or a momentary so-called micro sleep.

According to the invention, a selection unit, preferably a selection unit operable directly by the driver, is used to select a sole actuation of the means for actively applying an additional steering torque, a sole actuation of the means for actively applying a superposition steering angle, or a combined actuation of the means for actively applying an additional steering torque and the means for actively applying a superposition steering angle.

This selection can take place by activating an additional switch, for example. Thus, the driver selects whether he wishes a haptic feedback by an additional steering torque or an angle-adjusting correction of course by a superposition steering angle.

It is arranged for by the invention that autonomous driving, especially an independent parking maneuver, is performed by actuation of the means for actively applying an additional steering torque and actuation of the means for actively applying a superposition steering angle.

This embodiment is especially advantageous because the combination of the actuator means readjusting the steering angle and the torque-applying actuator means enables autonomous driving which is especially safe and comfortable for the driver, in particular a comfortable automatic parking maneuver.

According to the invention, the means for actively applying an additional steering torque includes an additional-torque actuator, preferably an electric motor or an electromagnet, an electronic regulating and controlling unit (ECU I), and a preferably redundant steering torque sensor.

Preferably a belt drive, a helical gear/worm gear pair, or a spur gearing, in particular a belt drive cooperating with the additional torque actuator, is used in this arrangement.

It is arranged for by the invention that the means for actively applying a superposition angle includes a superposition actuator, an electronic regulating and controlling unit (ECU II), and two preferably redundant sensors for determining the angle of rotation.

Advantageously, a gear is provided in this case, preferably a planetary gear cooperating with the additional torque actuator. An electric motor is favorably used as an additional torque actuator.

It is arranged for by the invention that the means for actively applying an additional steering torque and the means for actively applying a superposition steering angle generates an additional steering wheel torque, which is adapted to the current vehicle dynamics, especially the current lateral acceleration, as well as an adapted superposition angle.

It is arranged for by the invention that the means for actively applying an additional steering torque and the means for actively applying a superposition steering angle generates an additional steering wheel torque that is adapted to the vehicle's course and the shape of a road, as well as an adapted superposition angle.

This object is also achieved by a method for assisting a driver, which is characterized in that an additional steering torque can be applied actively and, additionally, a superposition steering angle can be applied actively.

In the above method, the additional steering toque and the superposition steering angle are preferably controlled independently.

This independent control is then favorably added to an already existing steering controller and integrated thereinto.

The method designates that the active application of an additional steering torque generates an antitorque which compensates, at least in part, a superposition torque produced by the active application of a superposition steering angle.

The method designates that an active application of an additional steering torque and an active application of a superposition steering angle will initiate a driver's activities detection, i.e. a determination whether the driver consciously directs the vehicle and is able to actively react to a changed driving situation, if applicable.

According to the invention, the method designates that the driver can select or preset a sole application of an additional steering torque, a sole application of a superposition steering angle, or a combination thereof.

According to the invention, the method designates that the active application of an additional steering torque and an active application of a superposition steering angle brings about autonomous driving, especially an independent parking maneuver.

According to the invention, the method designates that the active application of an additional steering torque is performed by an independent control according to signals of a preferably redundant steering wheel torque sensor.

According to the invention, the method designates that the active application of a superposition angle is performed by an independent control according to signals of two preferably redundant sensors for determining the angle of rotation.

According to the invention, the method designates that an additional steering wheel torque, which is adapted to the current vehicle dynamics, especially to the current lateral acceleration, and an adapted superposition angle are generated.

According to the invention, the method designates that an additional steering wheel torque adapted to the vehicle course and the shape of a road and an adapted superposition angle are generated.

According to the invention, the method designates that an additional steering wheel resetting torque is generated which conveys to the driver information about roadway conditions such as the coefficient of friction, utilization of the coefficient of friction, or tire adhesion.

According to the invention, the method designates that an additional steering wheel resetting torque is generated which conveys to the driver information about a road contact. Any occurring resetting forces are shown or simulated, respectively, in the steering system.

### BRIEF DESCRIPTION OF THE DRAWING

The invention will be explained in detail by way of an example in the subsequent description, making reference to the drawing (FIGURE).

The FIGURE shows schematically an embodiment of the power steering system of the invention with a magnetic additional torque actuator for the torque transmission and with an electromechanical actuator with a gear for a steering angle superposition.

### DETAILED DESCRIPTION OF THE DRAWING

The steering system illustrated in the FIGURE comprises a steering wheel 1, a steering column 2 connected to steering wheel 1 and equipped with two cardan joints 3, 4. The steering column 2 is connected to, or part of, a steering wheel shaft 5, which—by way of a steering gear 6, a steering rod 7, herein designed as a toothed rack—actuates the steering tie rods 8, 9 attached laterally at the toothed rack 7, whereby the wheels 10, 11 are turned.

In the toothed-rack steering system shown herein, hydraulic assistance is realized by means of a hydraulic pump 13 that is driven by means of the driving motor of the vehicle, e.g. by way of a belt drive 12, said pump delivering pressurized fluid to a steering valve 14 through a conduit 15. Pressure fluid can return into a supply tank 17 through a return conduit 16.

In the straight position of the steering wheel, a constant oil flow propagates through the steering valve adopting its neutral position (open center) and returns through the return conduit 16. The pressure in two chambers 18, 19 of a working cylinder 20 arranged at the toothed rack 7 is then of equal size. There is no steering assistance.

When the steering wheel 1 is turned, the toothed rack 7 und thus also the piston 21 are displaced. The pressure of the pressure fluid supports the movement of piston 21. As this occurs, valve 14 simultaneously causes pressure fluid to flow from one chamber into the other chamber so that the whole steering activity is assisted hydraulically.

This conventional hydraulic power steering system, as described above, includes a unit 22 for generating an additional torque, equipped with an additional torque actuator, herein an electromagnetic actuator 23, a first controlling unit ECU I 24 for actuating the additional torque actuator 23 and for evaluating signals of a steering torque sensor 25 and a sensor 26 for the position of the additional torque actuator 23. The electronic components are connected to an electric energy source 27.

The first controlling unit ECU I 24 and the torque sensor 25 are preferably of a redundant design.

Preferably, the unit 22 is designed as a functionally self-contained and independently manageable subassembly for the torque superposition. However, in particular the controlling unit ECU 24 can be arranged separately in the sense of the invention.

The steering wheel torque or steering torque, which is defined by the steering system characteristics and the forces that act, can be influenced actively by the unit for producing additional torque 22. In this arrangement, the additional torque actuator 23 produces an additional torque (additional steering torque) and applies it to the steering rod. It is possible to add the torque to the constructively predefined steering wheel torque, or to deduct it therefrom. The actuator torque can be transmitted with or without gear, or, as illustrated herein, directly onto part 28 of the steering wheel shaft 5.

In another, preferred design variant, an electric motor (not shown herein) is used as an additional torque actuator 23. The additional steering torque is then transmitted, preferably by way of a gear, in particular a belt drive, to the steering wheel shaft 5 or 28, respectively.

The power-assisted steering characteristics known to the driver is maintained upon failure of the unit 22 for producing an additional torque. The unit 22 itself is fail-silent, what means, it is disconnected in a case of failure.

Between the unit for producing an additional torque 22 and the steering gear 6, the steering shaft 5 is split up into a steering shaft portion 29 close to the steering wheel and a steering shaft portion 30 close to the steering gear. The portions 29 and 30 of the steering shaft 5 are operatively connected to a unit 31 for generating a superposition steering angle α. The unit 31 for the superposition function includes a superposition actuator, favorably an electric motor 32, and a superposition gear 33, favorably a planetary gear. The position of the electric motor 32 is measured by way of a sensor 34. The signals of the motor position sensor 34 and of two angular sensors, an angular sensor 35 for the angle-of-rotation position of the steering-wheel-side steering shaft 29 or the steering wheel 1, respectively, and an angular sensor 36 for the angle-of-rotation position of the steering-gear-side steering shaft 30 are sent to a second controlling unit ECU II 37.

The first and the second controlling unit ECU I 24 and ECU II 7 are interconnected by way of a communication line 38. It is also possible to arrange for a joint controlling unit or to configure these units as part of an overall steering controller.

The position of the wheels 10, 11, which is adjusted by the driver with the aid of the steering wheel 1, can be influenced actively by the unit 31 for generating the superposition steering angle α. In this arrangement, an additional steering angle α is produced by the superposition actuator 32.

Upon failure of the unit 31 for producing the superposition steering angle α, the power-assisted steering characteristics known to the driver is preserved. The unit 31 itself is fail-silent for this purpose. This means that it is disconnected in a case of fault.

The torque superposition renders it possible to vary the boosting characteristics curve by generating an additional torque. The boosting characteristics curve in this case implies the dependency of the steering wheel torque or actuating toque on the existing system pressure of the hydraulic assistance. Thus, the torque can be reduced by actively applying the additional torque and can be combined favorably with a superposition by an additional steering angle, thus augmenting the steering activity of the driver.

Active driver assistance can be realized in addition. To this end, a steering recommendation is given by a torque adaptation or torque variation, respectively, and simultaneously by an additional steering angle, or steering is rendered more difficult to the driver in order to alert him to danger, for example. Automatic steering maneuvers, which are performed without active steering of the driver, are especially favorably realized in a comfortable and safe manner.

1-11. (canceled)

12. A power steering system comprising:
a device for actively applying an additional steering torque; and
a device for actively applying a superposition steering angle.

13. A power steering system according to claim 12, wherein the device for actively applying an additional steering torque is a functionally self-contained and independently manageable subassembly, and the device for actively applying a superposition steering angle is a functionally self-contained and independently manageable subassembly.

14. A power steering system according to claim 12, wherein the device for actively applying an additional steering torque causes generation of an anti-torque, which compensates, at least in part, any superposition torque generated by the device for actively applying a superposition steering angle.

15. A power steering system according to claim 12, wherein a detection of activity of a driver is performed by actuating the device for actively applying an additional steering torque and by actuating the device for actively applying a superposition steering angle.

16. A power steering system according to claim 12, wherein a selection unit is used to select a sole actuation of the device for actively applying an additional steering torque, a sole actuation of the device for actively applying a superposition steering angle, or a combined actuation of the device for actively applying an additional steering torque and the device for actively applying a superposition steering angle.

17. A power steering system according to claim 12, wherein autonomous driving, such as an independent parking maneuver, is performed by an actuation of the device for actively applying an additional steering torque and an actuation of the device for actively applying a superposition steering angle.

18. A power steering system according to claim 12, wherein the device for actively applying an additional steering torque includes at least one of an additional-torque actuator, an electronic regulating and controlling unit (ECU I), and a redundant steering torque sensor.

19. A power steering system according to claim 12, wherein the device for actively applying a superposition angle includes a superposition actuator, an electronic regulating and controlling unit (ECU II) and two redundant sensors for determining the angle of rotation.

20. A power steering system according to claim 19, wherein the device for actively applying an additional steering torque and the device for actively applying a superposition steering angle generates an additional steering wheel torque that is adapted to the vehicle's course and the shape of a road, as well as an adapted superposition angle.

21. A power steering system according to claim 12, wherein the device for actively applying n additional steering torque and the device for actively applying a superposition steering angle generates an additional steering wheel torque, which is adapted to the current vehicle dynamics, especially the current lateral acceleration, as well as an adapted superposition angle.

22. A method for assisting a driver comprising:
actively applying an additional steering torque; and
actively applying a superposition steering angle.
